(19) United States
(12) Patent Application Publication
(10) Pub. No.: US 2026/0298167 A1
(43) Pub. Date: Oct. 1, 2026

(54) METHOD AND SYSTEM FOR CONTROLLING THE ENGINE TORQUE OF AN INTERNAL COMBUSTION ENGINE

(71) Applicant: VITESCO TECHNOLOGIES GmbH, Regensburg (DE)

(72) Inventor: Xavier MOINE, Toulouse (FR)

(21) Appl. No.: 19/099,433

(22) PCT Filed: Aug. 30, 2023
(86) PCT No.: PCT/EP2023/073743

§ 371 Date: Nov. 19, 2025

(30) Foreign Application Priority Data
Sep. 2, 2022 (FR) FR2208817

(51) Int. Cl. F02D 41/10; F02D 1/02; F02D 41/00; F02D 41/18; F02P 5/15

(52) U.S. Cl. CPC F02D 41/107; F02D 1/02; F02D 41/0002; F02D 41/18; F02P 5/1504

(57) ABSTRACT

A method for controlling the engine torque of an engine comprising:
a system (110) for regulating an entering air flow, and
an ignition system (130),
   in which method
on the basis of a torque demand (TQ_REQ), an air flow setpoint value (MAF_SP) is determined,
on the basis of MAF_SP, a position setpoint value (TPS_SP) of a movable control member of the regulating system (110) is determined,
the entering air flow (MAF) and the position of the movable control member (TPS) are measured,
a quantity of fuel to be injected (QTF) is calculated on the basis of MAF, and
an ignition angle (IGN_ANG) is calculated on the basis:
   of MAF if the difference between TPS and TPS_SP is greater than a predetermined position difference (EPS), and
   of MAF_SP if the difference between TPS and TPS_SP is less than EPS.

The present disclosure relates to a method and a system for controlling a drive torque of an internal combustion engine.

### TECHNICAL FIELD

The technical field of the present invention is thus the field of engine control for an internal combustion engine. The present disclosure is intended more particularly for nonautomobile applications and concerns rather, but not exclusively, engines of reduced size that are used, for example, on motorcycles. Such an engine can also be used for another application of an engine (lawnmower or other motorized tool, etc.).

The present disclosure concerns more particularly still internal combustion engines in which a valve, referred to as a butterfly, controls the air flow entering the engine, said butterfly being operated in a controlled manner, usually electrically. In such an engine, the operation of the user on a pedal, termed accelerator pedal, or a handle, or a lever, or the like, is translated into a torque demand (request), and a control and management system will then determine setpoint values concerning, for example, the opening angle of the butterfly so that the engine provides the torque corresponding to the torque request of the user.

### PRIOR ART

In a conventional manner, the torque request is translated, by an electronic management and control unit or controller, into a setpoint for air flow entering the engine by a reverse torque model and, in turn, the air flow setpoint is translated into an opening position (or angle) setpoint of the butterfly by a reverse air flow model. Furthermore, in a conventional manner, a direct model is used by the controller for fuel injection and ignition: on the basis of a certain number of data obtained using sensors, such as (nonexhaustive illustrative list) the opening angle of the butterfly, the speed of the engine, the intake pressure, the temperature, etc., an estimated air flow of the air which has actually entered the engine is calculated. This value of the air flow will make it possible to determine, on the one hand, the quantity of gasoline to be provided to the engine to carry out a combustion and, on the other hand, the maximum torque that can be provided by the engine. Depending on the available maximum torque and on the demanded torque (torque request), an ignition angle is determined. If the available torque is greater than the actually demanded torque, an ignition advance reduction will be carried out to obtain the setpoint value of the torque.

It will be noted that a large number of calculations are necessary and that maps are used. A small error in the calculations and/or the maps can lead to a loss of efficiency of the engine of the order of one percent. This corresponds to an increase in fuel consumption of the same order of magnitude with respect to an optimized fuel consumption.

In the automobile field, the estimated air flow and a measured air flow are permanently compared and a correction is applied to the opening of the butterfly to make these values coincide. In this way, the errors between the estimated flow and the measured flow are compensated for. A motor vehicle generally comprises an intake manifold of relatively large volume. By virtue of this large-volume manifold, the controller can adjust the position of the butterfly quickly and even during a transient state, and the corrections applied cannot be perceived by the driver and make it possible to have an optimized operation as soon as a steady state is achieved.

For nonautomobile applications, the transient phases are generally shorter and the controller does not have sufficient time to act. The control then occurs after the transient phase and the user is aware of the regulation, since the latter occurs by modifying the torque provided by the engine not during the transient phase but when the user expects to be in steady state. This control also causes the engine to operate under nonoptimal combustion conditions during the transient phase and at the start of the steady phase and therefore leads to an increase in the fuel consumption. In summary, whereas in the automobile field the controller acts during the transient phases and reaches steady state with the proper settings, in other, nonautomobile applications, the operating mode used for the automobile field can lead to interventions of the controller that are noticeable to the user.

### SUMMARY

The present disclosure will improve the situation. It aims in particular to provide a solution for controlling the torque of an engine, in particular during transient phases, which, on the one hand, makes it possible to optimize the fuel consumption, and, on the other hand, limits or even eliminates effects that are noticeable to the final user. Preferably, this system will not require the use of new components in an engine in order to be able to be implemented.

What is proposed is a method for controlling the engine torque of an internal combustion engine, said engine comprising:
at least one system for regulating an air flow entering the engine, comprising a movable control member whose position makes it possible to act on the air flow entering the engine, and
an ignition system with a system for determining the ignition angle, in which method, on the basis of a torque demand of a user of said engine, an air flow setpoint value is determined,
in which method, on the basis of the air flow setpoint value, a setpoint value of the position of the movable control member of the regulating system is determined,
in which method the air flow entering the engine and the position of the movable control member are measured, and
in which method, on the basis of measured and/or calculated variables, on the one hand, a quantity of fuel to be injected, and, on the other hand, an ignition angle are determined.

According to the present disclosure, the quantity of fuel to be injected is calculated on the basis of the measured entering air flow, and the ignition angle is calculated on the basis:
of the measured entering air flow, which is possibly corrected, if the difference between the measured position of the movable control member and the setpoint value of the position of the movable control member is greater than a predetermined position difference, and
of the setpoint value of the entering air flow if the difference between the measured position of the movable control member and the setpoint value of the position of the movable control member is less than said predetermined position difference (here, the one or other alternative also comprises the case where the difference is equal to the predetermined position difference).

Thus, it is possible to avoid any unwanted ignition advance reduction. As long as the position of the movable control member is remote from its setpoint position, the ignition angle is calculated in a “conventional” manner using the measured entering air flow value. However, as soon as the position of this member approaches its setpoint position, the ignition angle is calculated using the setpoint value of the position of the movable control member and this makes it possible to avoid any advance reduction, and therefore any degradation of fuel consumption, as soon as the engine approaches its steady state.

A first variant embodiment provides that the predetermined position difference is a fixed value.

Another variant provides that the predetermined position difference is a value dependent on parameters, for example on the position of the movable member itself and/or on the engine speed and/or on the atmospheric pressure and/or on the temperature.

According to a preferred embodiment, corresponding to most of the current internal combustion engines, the system for regulating the air flow entering the engine comprises a throttle body in which the movable control member is a valve, or butterfly, which is pivotably mounted and makes it possible to modify the air passage cross section in said throttle body, and in which the position of the butterfly is determined by its opening angle.

In this preferred embodiment, the predetermined position difference of the movable control member corresponds to an angular position difference of the butterfly of less than 1°, preferably less than 0.5° and preferably still less than 0.1°. Specifically, there should be provided a relatively small difference to maintain precision in the calculations carried out.

According to another aspect, what is proposed is an internal combustion engine comprising:
at least one system for regulating an air flow entering the engine, comprising a movable control member whose position makes it possible to act on the air flow entering the engine, and
an ignition system with a system for determining the ignition angle,
wherein it further comprises an electronic control unit for implementing each of the steps of a method described above.

In this internal combustion engine, the system for regulating an air flow entering said engine advantageously comprises:
a throttle body in which the movable control member is a valve, or butterfly, which is pivotably mounted and makes it possible to modify the air passage cross section in said throttle body, and
an electric motor for varying the angular position of said butterfly.

According to another aspect, what is proposed is a computer program comprising instructions for implementing a method presented above when this program is executed by a processor, in particular an electronic control unit of an internal combustion engine.

According to another aspect, what is proposed a computer-readable nonvolatile storage medium on which such a program is stored.

### BRIEF DESCRIPTION OF THE FIGURES

Further features, details and advantages will become apparent on reading the following detailed description, and on studying the appended drawing, in which:

FIG. 1A and FIG. 1B illustrate a torque control method known from the prior art.

FIG. 2 schematically illustrates a method according to the present disclosure.

FIG. 3 schematically illustrates an engine for implementing a method according to the present disclosure.

### DESCRIPTION OF THE EMBODIMENTS

The present description is given in relation to an internal combustion engine 100 (FIG. 3) of the controlled-ignition four-stroke type. In a manner known to a person skilled in the art, an internal combustion engine comprises one or more cylinders inside each of which can be found a combustion chamber. Each combustion chamber has associated therewith at least one intake valve for managing gas flows entering the combustion chamber and at least one exhaust valve for managing gas flows leaving the combustion chamber. At least one air inlet is provided with a system 110 for regulating the entering air flow. This system corresponds in general to a device referred to as a throttle body (or throttle) for varying the fresh air flow entering the engine. In the illustrated embodiment, the position of the butterfly, that is to say of a valve which is pivotably mounted to modify the fresh air passage cross section of a supply duct, is controlled by an electric motor 120. It is important to know the air flow entering the engine so as to determine as precisely as possible the quantity of fuel to be injected in order to optimize the combustion so as to limit both the fuel consumption and the emission of pollutants. To optimize the combustion of the fuel injected, an ignition engine angle should be determined, that is to say a position of the engine (in °CRK) at which a spark is produced in at least one cylinder. Hence, an ignition system 130 is thus provided in the engine. The ignition system 130 comprises, for example, at least one spark plug per cylinder and means for producing a spark at one end of each spark plug upon receipt of a corresponding instruction.

An electronic management and control unit or controller 140 receives information from sensors and sends instructions to the various systems, for example to the system 110 for regulating the entering air flow in order to act on the electric motor 120 and to modify the opening angle of the butterfly, or else to the ignition system 130. Within this controller 140 there can be found in particular a system 150 for determining the ignition angle, which makes it possible to determine at which moment, corresponding to a precise position of the engine, expressed by a person skilled in the art in CRK.

Such a structure is known to a person skilled in the art and is not described in more detail here.

The engine 100 is, for example, intended for a nonautomobile use, for example for a motorcycle, a tool such as a lawnmower, etc.

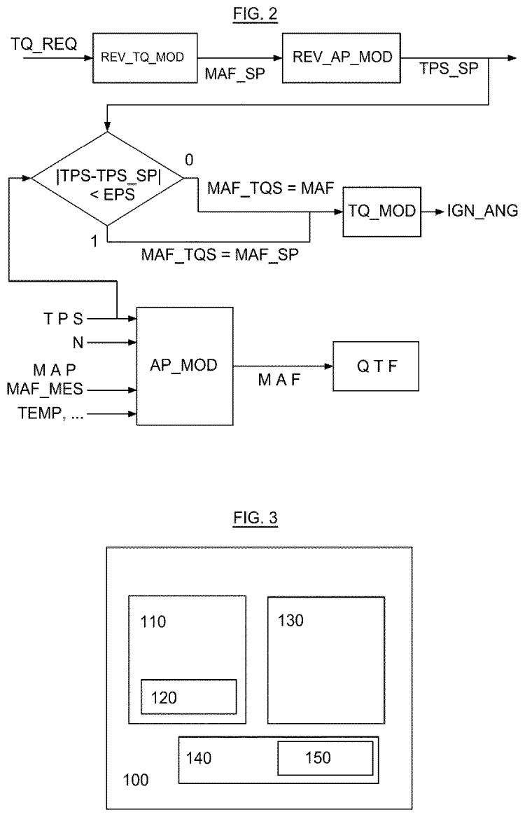

FIG. 2 illustrates a method known from the prior art for controlling the torque provided by the engine. As input, a user makes a torque demand TQ_REQ and, on the basis of this demand, a system referred to, for example, as a torque structure provides a setpoint value TPS_SP for the position of the butterfly of the system 130 for regulating the entering air flow, a quantity QTF of fuel to be injected and an ignition angle value IGN_ANG.

The torque structure of FIG. 2 operates in the following way. On the basis of the request TQ_REQ of the user, a setpoint value of an entering air flow MAF_SP is determined using a reverse torque model (REV_TQ_MOD) which can be a reverse map. What is concerned is a reverse model since, conventionally, a torque is determined on the basis, inter alia, of an entering fresh air flow. To obtain this entering air flow MAF_SP, the butterfly (or another system) should be set to a setpoint position TPS_SP. The latter is also obtained by a reverse model REV_AP_MOD, or reverse air flow model. This can also be a reverse map.

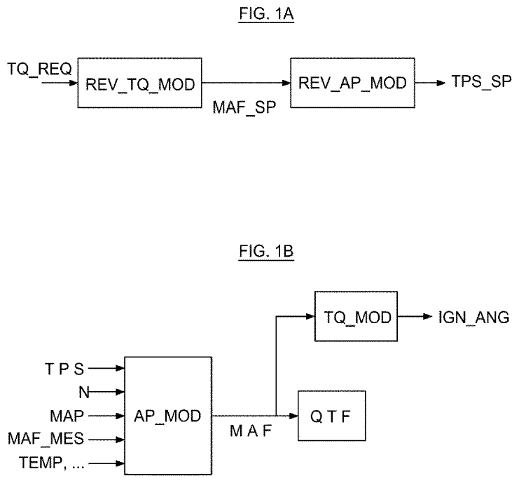

The quantity of fuel to be injected QTF and the ignition angle IGN_ANG are determined by direct models. Input data are illustrated by way of nonlimiting examples in FIG. 1B. There is thus, for example, the measured value TPS of the position of the butterfly, the engine speed N, the atmospheric pressure MAP which can be measured or else determined by software on the basis of measurements of pressure in the engine, the measured entering air flow MAF_MES (measured directly or calculated on the basis of measurements from sensors, for example pressure, temperature, etc.), the temperature TEMP of the entering air, etc.

The (direct) air flow model AP_MOD then makes it possible to calculate an entering air flow MAF as a function of all these parameters. This value is then used to calculate the quantity of fuel to be injected QTF by considering, for example, that the mixture is a stoichiometric mixture.

Taking account of the calculations carried out, it appears to a person skilled in the art that there can be a difference between the value MAF and the setpoint value MAF_SP. On the basis of this value MAF, a direct torque model (TQ_MOD) makes it possible to determine a maximum torque which can be provided by the engine. If this maximum torque value is greater than the request of the user (TQ_REQ), it is then possible to act on the ignition advance to adapt the torque provided at the request of the user. The system 150 for determining the ignition angle then limits the ignition advance if necessary. This then leads to a degradation of the efficiency of the engine, thus corresponding to an increase in its fuel consumption.

In steady state, such a structure operates well and makes it possible to obtain a good efficiency for the engine. It also operates for the transient states in the automobile field since, usually, the engines of motor vehicles comprise an intake manifold of large volume. In such engines, the controller 140 is usually capable of adjusting the position of the butterfly during a transient phase and the user does not feel the action of the controller 140 at all when driving. As explained in the preamble, for engines intended for nonautomobile applications, the transient phases are often shorter, the volume of the intake manifold is much reduced and the action of the controller 140 still occurs during the steady phase following a transient phase and can then be felt by the user. Furthermore, a degradation of the efficiency and therefore an increase in the fuel consumption can occur.

The present disclosure proposes modifying the torque structure presented in FIGS. 1A and 1B so as to also adapt to nonautomobile applications.

It is proposed here to decouple the determination of the quantity of fuel to be injected from the determination of the ignition angle. Furthermore, whereas the adjustment of the position of the butterfly was decoupled from the determination of the quantity of fuel to be injected and from the ignition angle, it is proposed to take into account the position setpoint of the butterfly TPS_SP in order to determine the ignition angle IGN_ANG.

The determination of the setpoint value of the position of the butterfly TPS_SP is carried out as explained above with reference to FIG. 1A: on the basis of a request of a user, TQ_REQ, using successively a reverse torque model REV_TQ_MOD and a reverse air flow model REV_AP_MOD, there are successively determined a setpoint value of air flow entering the engine MAF_SP and then a setpoint value of the position of the butterfly TPS_SP.

The quantity of fuel to be injected QTF is for its part also determined as explained with reference to FIG. 1B: on the basis of data measured by sensors or else data calculated (on the basis of measured data in particular) by the controller 140 or another electronic unit associated with the engine, a direct air flow model AP MOD calculates an air flow entering the engine MAF and, on the basis of the latter, the quantity of fuel to be injected is determined, for example, by the controller 140 or another electronic control and management unit (or unit known as an ECU).

The ignition angle IGN_ANG is determined on the basis of a variable MAF TQS which can assume two values, and more precisely either the value of the air flow MAF determined by the direct air flow model AP_MOD or the setpoint value MAF_SP determined by the reverse torque model REV_TQ_MOD.

It is proposed here to make the value of the variable MAF_TQS depend on the difference between the angular position of the butterfly TPS and the setpoint value TPS_SP. When the angular position of the butterfly TPS is close to the setpoint value TPS_SP, it is then proposed to give the variable MAF_TQS the setpoint value of the entering air flow MAF_SP, whereas, if the angular position of the butterfly is still remote from its setpoint value, the variable MAF_TQS will then assume the value of the air flow entering the engine MAF that is determined by the direct air flow model AP_MOD.

The controller 140 then compares the values TPS_SP and TPS. It carries out the difference between these two values and takes the absolute value thereof: |TPS−TPS_SP|.

If this value is less than (or less than or equal to) a predetermined difference (epsilon or EPS), it is then considered that the angular position of the butterfly is close to its setpoint value.

In FIG. 2, the Response to the Question of Knowing Whether: |TPS−TPS_SP|<EPS is yes corresponds to the value 1, whereas the negative response corresponds to the value 0.

The value EPS can be a fixed value or else be a value dependent on parameters, for example the opening angle of the butterfly (a small variation when the butterfly is virtually closed can lead to a large variation in the air flow whereas, when the butterfly is wide open, a small variation is less noticeable on the air flow), the engine speed or else the atmospheric pressure. Whether it is fixed or dependent on variables, this value EPS preferably remains small: it is advantageously less than 1°, more advantageously still less than 0.5° and even less than 0.2°. If it is fixed, it is possible to have, for example, EPS=0.1°. This angle corresponds to the angular position of the butterfly with respect to its pivot axis in its throttle body.

With the method proposed here, in relation to the method of the prior art presented above, everything proceeds in the same way, even in the transient phase, until the butterfly reaches, or is very close to, its setpoint position. At this time, to avoid any unwanted advance reduction, and thus any degradation in terms of fuel consumption, the advance reduction calculation is done using the setpoint value of the air flow. Thus, when the butterfly approaches its final position (corresponding to the setpoint position), any unwanted ignition advance reduction is avoided. Optimal fuel consumption in the engine is thus obtained.

In the case where, for example, the measured (calculated) air flow MAF were to be greater that the setpoint air flow (MAF_SP), the engine would then provide a torque greater than the demanded torque (TQ_REQ), but the combustion would take place under optimal conditions from the point of view of fuel consumption. This is without consequence since a torque which is too high by a few percent is not noticeable to the user who will automatically and naturally adapt his torque request to the response of his motorcycle, his tool or the like. Thus, nothing will be felt by the user and the fuel consumption remains optimal. Conversely also, if MAF is less than MAF_SP, the torque obtained will be less but there will be no unwanted ignition advance reduction. Here too, nothing will be felt by the user who will quite naturally adapt his request, and the torque structure ensures optimization of the fuel consumption.

### INDUSTRIAL APPLICATION

The present technical solution can be applied in particular in engine control for improving fuel consumption and also improving driving comfort for the user.

The proposed method, and the corresponding means for implementing this method, make it possible to have better control over the ignition angle in the engine while avoiding any unwanted advance reduction when the engine is in a steady operating phase. It is then possible to optimize the fuel consumption and to limit the discharge of polluting materials.

The implementation of the present disclosure facilitates engine control and makes it possible under certain conditions to reduce the stress on the controller. Specifically, if the position of the butterfly varies slightly while remaining close to the setpoint value, the ignition angle is calculated using the setpoint value. Thus, a small positional error of the butterfly does not lead to a degradation in the fuel economies.

The method according to the present disclosure, illustrated in FIG. 2, is also less sensitive to the variations which can exist from one engine to the other. The fact of using the setpoint value in steady state to determine the ignition angle makes the system less sensitive to spreads which may exist from one engine to the other.

It is considered that a user is insensitive to torque level errors up to approximately 5%. On the other hand, to limit the polluting emissions and CO2, a degradation of the fuel consumption of the order of 1% is not acceptable. The torque structure proposed here makes it possible, while avoiding any ignition advance reduction, to maintain optimum fuel consumption without having an impact on user comfort.

The present disclosure is not limited to the exemplary embodiments proposed and to the stated variants described above, only by way of example, but encompasses all the variants that may be envisioned by a person skilled in the art within the scope of the protection sought.

1. A method for controlling the engine torque of an internal combustion engine, said engine comprising:
a crankshaft, characterized by a top dead center,
at least one system (110) for regulating an air flow entering the engine, said system comprising a movable control member whose position makes it possible to act on the air flow entering the engine, and
an ignition system (130) with a system (150) for determining the ignition angle, defining the angle of the crankshaft with respect to the top dead center of said crankshaft at the time of ignition of the engine, in which method:
a. on the basis of a torque demand (TQ_REQ) of a user of said engine, an air flow setpoint value (MAF_SP) is determined,
b. on the basis of the air flow setpoint value (MAF_SP), a position setpoint value (TPS_SP) of the movable control member of the regulating system (110) is determined,
c. the air flow (MAF) entering the engine and the position of the movable control member (TPS) are measured, and
d. on the basis of the determined torque demand (TQ_REQ) and of the measured entering air flow (MAF), on the one hand, a quantity of fuel to be injected (QTF), and, on the other hand, an ignition angle (IGN_ANG) are determined,
the method being characterized in that:
the quantity of fuel to be injected (QTF) is calculated on the basis of the measured entering air flow (MAF), and
the ignition angle (IGN_ANG) is calculated on the basis:
of the measured entering air flow (MAF) if the difference between the measured position of the movable control member (TPS) and the setpoint value of the position of the movable control member (TPS_SP) is greater than a predetermined position difference (EPS), and
of the setpoint value of the entering air flow (MAF_SP) if the difference between the measured position of the movable control member (TPS) and the setpoint value of the position of the movable control member (TPS_SP) is less than said predetermined position difference (EPS).

2. The method as claimed in claim 1, wherein the predetermined position difference (EPS) is a fixed value.

3. The method as claimed in claim 1, wherein the predetermined position difference (EPS) is a value dependent on parameters, for example on the position of the movable member itself (TPS) and/or on the engine speed (N) and/or on the atmospheric pressure and/or on the temperature.

4. The method as claimed in one of claims 1 to 3, wherein the system (110) for regulating the air flow entering the engine comprises a throttle body in which the movable control member is a valve, or butterfly, which is pivotably mounted and makes it possible to modify the air passage cross section in said throttle body, and wherein the position of the butterfly is determined by its opening angle.

5. The method as claimed in claim 4, wherein the predetermined position difference (EPS) of the movable control member corresponds to an angular position difference of the butterfly of less than 1°, preferably less than 0.5° and preferably still less than 0.1°.

6. An internal combustion engine (100) comprising:
a crankshaft, characterized by a top dead center,
at least one system (110) for regulating an air flow entering the engine, comprising a movable control member whose position makes it possible to act on the air flow entering the engine, and
an ignition system (130) with a system (150) for determining the ignition angle, defining the angle of the crankshaft with respect to the top dead center of said crankshaft at the time of ignition of the engine,
wherein it further comprises an electronic control unit (150) for implementing each of the steps of a method as claimed in one of claims 1 to 5.

7. The internal combustion engine (100) as claimed in claim 6, wherein the system (110) for regulating an air flow entering said engine comprises:
a throttle body in which the movable control member is a valve, or butterfly, which is pivotably mounted and makes it possible to modify the air passage cross section in said throttle body, and
an electric motor (120) for varying the angular position of said butterfly.

8. A computer program comprising instructions for implementing a method as claimed in one of claims 1 to 5 when this program is executed by a processor, in particular an electronic control unit of an internal combustion engine.

9. A computer-readable nonvolatile storage medium on which a program for implementing a method as claimed in one of claims 1 to 5 is stored when this program is executed by a processor, in particular an electronic control unit of an internal combustion engine.
